(19) United States
(12) Patent Application Publication
(10) Pub. No.: US 2012/0206825 A1
(43) Pub. Date: Aug. 16, 2012

(54) REFLECTOR-CONCENTRATOR UNIT, METHOD OF MANUFACTURING THE SAME, AND SOLAR COLLECTOR DEVICE COMPRISING SAID REFLECTOR-CONCENTRATOR UNIT

(75) Inventors: Victor Martinez Moll, Illes Balears (ES); Ramon Pujol Nadal, Illes Balears (ES); Jaime Montesino Semper, Illes Balears (ES); Andreu Moia Pol, Illes Balears (ES); Huascar Paz Bernales, Illes Balears (ES); Gabriel Trobat Obrador, Illes Balears (ES)

(73) Assignee: TECNOLOGIA SOLAR CONCENTRADORA, S.L., Barcelona (ES)

(21) Appl. No.: 12/810,899

(22) PCT Filed: Dec. 26, 2008
(86) PCT No.: PCT/ES08/00802

§ 371 Date: Nov. 2, 2010

(30) Foreign Application Priority Data
Dec. 28, 2007 (ES) P200703463

(51) Int. Cl. G02B 5/10; B29D 11/00

(52) U.S. Cl. 359/853; 264/1.9

(57) ABSTRACT

A reflector-concentrator unit including a sandwich structure with an upper lamina, a lower lamina, a filler layer between both, and a frame. The upper lamina has associated therewith an outer reflective surface to reflect incident rays and to concentrate them in a linear focus. The material of the filler layer is adhered to the upper and lower laminas of the sandwich structure and to the frame and is rigid enough to precisely assure a predetermined stable operating position of the upper lamina in relation to the frame. The frame includes positioning configurations usable to precisely position the reflector-concentrator unit and the associated reflective surface in relation to an external element of an installation.

### TECHNICAL FIELD

The present invention comprises a reflector-concentrator unit essentially formed by a sandwich structure and a frame, where an upper lamina of the sandwich structure supports a reflective surface or has a polished outer surface which functions as the reflective surface. The present invention also relates to a method of manufacturing such reflector-concentrator unit.

The reflector-concentrator unit of the present invention mainly, though not exclusively, has an application in the field of the solar energy collectors based on the concentration of the sun's reflected rays.

The present invention also relates to a method of manufacturing said reflector-concentrator unit and to a solar collector device comprising the reflector-concentrator unit.

### BACKGROUND OF THE INVENTION

Patent GB-A-1581253 describes a collector device comprising a fixed reflector with reflective surfaces supported on a sandwich structure made up of a sheet of metal, filler material and a sheet of metal. In one embodiment, the reflective surfaces are provided by a polished outer surface of the upper sheet of metal. Several sandwich structures are arranged next to one another and their side edges are joined together in a tight manner so as to function like a roof of a building. Several linear receivers are integrated in a mobile structure supported by a tracking mechanism, comprising a plurality of pivoting supporting arms assembled on a fixed structure in turn supporting the reflector, such that the mobile structure, the pivoting arms and the fixed structure function like an articulated parallelogram for guiding the movement of all the receivers in unison with respect to their respective reflective surfaces along a circular path selected for following the maximum concentration of the sun's reflected rays. The tracking mechanism includes a drive arm connected to the mobile structure and driven by a motor to move the mobile structure along a portion of said circular path synchronously with the relative movement of the sun.

A drawback of the reflector of the device of patent GB-A-1581253 is that the securing of the sandwich structure to supporting members of the fixed structure is performed by means of feet fixed to the lower lamina of the sandwich structure, whereas the connection between the lower lamina and the upper lamina supporting the reflective surface is performed exclusively by means of the filler layer without there being any configuration or method which precisely assures the position of the lower lamina with respect to the upper lamina. Accordingly, precise positioning of the reflective surface with respect to the fixed structure cannot be assured, and given that there is also assembled on this same fixed structure the tracking mechanism which supports and moves the corresponding linear receiver, the precise positioning of the linear receiver or of the path that it will follow with respect to the reflective surface cannot be assured. This lack of precision in the relative positions of the reflector and the receiver can mean that the linear receiver will be located and/or will move offset from the area of maximum convergence of rays reflected by the reflector, whereby the benefit of concentrating the sun's rays would be lost to a greater or lesser extent.

Nor does patent GB-A-1581253 solve the problem of manufacturing a sandwich structure element with an arched upper lamina, a lower lamina and a filler material between both using a filler material which is in liquid or past form at the time of shaping, and achieving that the obtained sandwich structure has a rigid enough structure and that the upper lamina is precisely positioned with respect to said structure.

### DISCLOSURE OF THE INVENTION

Throughout this specification, the term “solar collector device” is used to designate a device the function of which is to transform solar radiation into thermal energy (thermal solar collector device) or electric energy (photovoltaic solar collector device), which can be made up of several sub-systems such as receiver, reflector, tracking mechanism. The term “receiver” is used to designate a component of a solar collector in which the transformation of the solar radiation into thermal or electric energy takes place. The term “reflector-concentrator” is used to designate a sub-system present in a solar collector the function of which is to concentrate the solar radiation and direct it towards the receiver using a high specular reflectance surface as a means for concentrating the energy. This increases the efficiency of the energetic transformation while at the same time the necessary receiver surface is reduced. The term “linear focus” is used to designate an area of the space where the radiation reflected by the reflector-concentrator reaches its maximum density and which has an elongated, substantially rectilinear shape. A linear focus is produced by a reflective parallel ruled concave surface, for example, a reflective surface with a parabolic or approximately parabolic cross-section, several reflective surface sections, each with a parabolic or approximately parabolic cross-section, or a plurality of planar reflective surface sections arranged like a Fresnel mirror. Thus, although in some theoretical cases the linear focus can have the shape of a geometric line, in practice it takes up a certain elongated, approximately prismatic volume in space (see, for example, patent JP-A-10026423). The term “tracking mechanism” is used to designate a system which allows the positioning of either the reflector-concentrator, of the receiver, or of the assembly of both, according to the position of the sun, such that the linear focus produced by the reflector-concentrator at all times coincides with the position of the receiver.

According to a first aspect, the present invention provides a reflector-concentrator unit comprising a sandwich structure with an upper lamina, a lower lamina and a filler layer between both, where said upper lamina has or supports an outer reflective surface and is shaped to reflect substantially or approximately parallel incident rays and to concentrate the reflected rays in a linear focus. The reflector-concentrator unit of the present invention is characterized in that the sandwich structure is associated with a frame, such that they jointly form the mentioned reflector-concentrator unit. The material of the filler layer is adhered to at least said upper lamina of the sandwich structure and to said frame and is rigid enough to precisely assure a predetermined stable operating position of the upper lamina in relation to the frame. Furthermore, the frame defines positioning configurations which are usable to precisely position the reflector-concentrator unit, and accordingly the reflective surface associated therewith, in relation to an external element of an installation.

The frame preferably comprises opposite end plates, transverse to the direction of said linear focus, attached to one another by spacer members. Each of the mentioned end plates has an upper edge configured to cooperate with a corresponding end portion of the upper lamina to position the upper lamina and its reflective surface in relation to said frame. The end plates of the frame are connected to one another, for example, by spacer members arranged through the filler layer. These spacer members furthermore perform the function of transmitting loads applied on the upper lamina to the end plates.

The reflector-concentrator unit can include one or more upper laminas, and each upper lamina can define one or more concave reflecting elements, each capable of concentrating the reflected rays in a respective linear focus. Optionally, when the upper lamina or one of the upper laminas has several reflecting elements, every two of the latter have adjacent side edges which converge in a longitudinal linear fold, in which case, the upper edge of each of the end plates defines a vertex which cooperates with the concave part of said linear fold to position the upper lamina and its reflective surface in relation to said frame. Furthermore, the upper edge of each end plate defines several concave arched seats, one on either side of each vertex, for supporting end portions of the upper lamina corresponding to said reflecting elements and to contribute to positioning the corresponding upper lamina in relation to the frame.

With this construction, the material of the filler layer functions as a binder capable of providing solidity to the sandwich structure and of precisely maintaining the relative positions of the reflective surface and the frame. Thus, the reflector-concentrator unit according to the present invention has the shape of a significantly rigid planar body, formed by a reduced number of elements, which is provided with a relatively large reflective surface and positioning configurations located in precise positions in relation to the reflective surface.

According to a second aspect, the present invention provides a method of manufacturing a reflector-concentrator unit of the type described above, comprising the following steps. Firstly, a mold is provided in the form of a box with a shaped bottom according to the negative of said reflective surface of the reflector-concentrator unit. Next, one or more upper laminas are introduced in said mold with the reflective surface facing said bottom. Then, a frame is introduced in the mold above the upper lamina or upper laminas. Next, a flowable material is poured in the mold above said frame and the upper lamina or upper laminas, filling the mold up to a predetermined level, said flowable material being capable of expanding and hardening to form said filler layer and of adhering to at least said frame and to the upper lamina or upper laminas. Then, said lower lamina is introduced in the mold above said flowable material. Finally, a cover is placed on the lower lamina fixing it at a predetermined distance from the shaped bottom and allowing the flowable material to expand and harden until forming the filler layer. The pressure produced by the expansion of the flowable material contributes to pressing the upper lamina or the upper laminas against the bottom of the mold in order to shape them according to the form of the latter.

The method optionally comprises providing the frame with positioning configurations envisaged for being used to precisely position said finished reflector-concentrator unit, and accordingly the reflective surface associated therewith, in relation to an external element of an installation, for example, an element of a fixed structure, an element of a fixed support for a collector, or an element of a tracking mechanism of a collector, among others. These positioning configurations can be used advantageously to precisely position the frame in relation to the shaped bottom of the mold during the molding operation. Thus, it is not indispensable for there to be a direct contact relationship between the frame and the upper lamina or upper laminas in order to assure a precise relative positioning between both since this precise positioning is assured by the positioning of the frame in relation to the shaped bottom of the mold during the molding operation and by the filler material once the latter has hardened.

The method also preferably comprises forming the frame with opposite end plates, transverse to the direction of said linear focus, and positioning the frame in the mold with at least part of an upper edge of each end plate pressing a corresponding end portion of the upper lamina or of each upper lamina against the shaped bottom of the mold. Opposite end portions of the lower lamina or of the several lower laminas can optionally be supported on lower edges of the end plates inside the mold, although this is not indispensable if other alternative means are used for supporting the lower lamina or the lower laminas inside the mold. The frame can be formed by connecting the end plates to one another by means of spacer members. In this case, the frame would be introduced in the mold with said spacer members positioned so as to be embedded in the filler layer once the flowable material has expanded and hardened.

To produce a reflector-concentrator unit with two or more reflective surface portions, the method envisages forming the shaped bottom of the mold with two or more mold portions, each according to the negative of a reflecting element capable of concentrating the reflected rays in a respective linear focus, where adjacent edges of every two of said adjacent mold portions converge in at least one groove. In addition, the method comprises forming the upper lamina or each upper lamina with at least one longitudinal linear fold between at least two reflecting elements and introducing the upper lamina or the upper laminas in the mold placing each linear fold in coincidence with one of said grooves in the shaped bottom of the mold. Likewise, the method also comprises forming the frame with one or more vertexes in an upper edge of each end plate, and introducing the frame in the mold placing the mentioned vertex or vertexes of each end plate in coincidence with the linear fold or the linear folds of the upper lamina or upper laminas to press the linear fold against the shaped bottom of the mold. The remaining steps of pouring the flowable material, introducing the lower lamina, placing and fixing the cover, and allowing the flowable material to expand and harden until forming the filler layer are analogous to those described above.

In a preferred embodiment, the upper lamina is an aluminum alloy sheet which has a polished outer surface performing the function of the reflective surface. The lower lamina can be a sheet of any sufficiently rigid material, for example, plastic, aluminum or galvanized steel, among others. The end plates and the spacer members are preferably made of a metal, such as aluminum or galvanized steel, although other materials are not ruled out, such as possibly fiber reinforced polymeric materials, or materials which allow producing the frame by molding.

According to a third aspect, the present invention provides a solar collector device using a reflector-concentrator unit according to the present invention or manufactured according to the method of the present invention to reflect the sun's rays, and at least one supported elongated receiver which can be supported in different ways in relation to the reflector-concentrator unit. A first possibility comprises, for example, fixedly supporting the receiver in the position of said linear focus with respect to the reflector-concentrator unit, in which case only the reflector-concentrator unit or the reflector-concentrator unit and receiver assembly can be moved according to the changes in the relative position of the sun to constantly receive the sun's incident rays substantially in the direction normal to the reflective surface. Alternatively, the reflector-concentrator unit can be fixedly supported and the receiver can be moved to track the maximum convergence of the sun's reflected rays as the relative position of the sun changes.

### BRIEF DESCRIPTION OF THE DRAWINGS

The previous and other features and advantages will be more fully understood from the following detailed description of several embodiments with reference to the attached drawings, in which:

FIG. 1 is a perspective view of a reflector-concentrator unit according to a first embodiment of the first aspect of the present invention with a single upper lamina and a single reflecting element;

FIG. 2 is an enlarged partial perspective view of a detail of the reflector-concentrator unit of FIG. 1;

FIG. 3 is an exploded perspective view of some components of the reflector-concentrator unit of FIG. 1;

FIG. 4 is an enlarged partial cross-section view showing the construction of the frame of FIG. 3;

FIG. 5 is an enlarged and partially sectioned partial perspective view showing the construction of the reflector-concentrator unit of FIG. 1;

FIG. 6 is a perspective view of a reflector-concentrator unit according to a second embodiment of the first aspect of the present invention with a single upper lamina and two reflecting elements;

FIG. 7 is a perspective view of a reflector-concentrator unit according to a third embodiment of the first aspect of the present invention with a single upper lamina and four reflecting elements;

FIG. 8 is a perspective view of a reflector-concentrator unit according to a fourth embodiment of the first aspect of the present invention with two upper laminas and four reflecting elements;

FIG. 9 is a schematic perspective view illustrating a method of manufacturing a reflector-concentrator unit like the one shown in FIG. 1 according to a first embodiment of the second aspect of the present invention;

FIG. 10 is a schematic perspective view illustrating a method of manufacturing a reflector-concentrator unit like the one shown in FIG. 6 according to a second embodiment of the second aspect of the present invention;

FIG. 11 is a schematic perspective view illustrating a method of manufacturing a reflector-concentrator unit like the one shown in FIG. 7 according to a third embodiment of the second aspect of the present invention;

FIG. 12 is a schematic perspective view illustrating a method of manufacturing a reflector-concentrator unit like the one shown in FIG. 8 according to a fourth embodiment of the second aspect of the present invention;

FIG. 13 is a schematic depiction of a solar collector device according to a first embodiment of the third aspect of the present invention;

FIG. 14 is a schematic depiction of a solar collector device according to a second embodiment of the third aspect of the present invention; and

FIG. 15 is a schematic depiction of a solar collector device according to a third embodiment of the third aspect of the present invention.

### DETAILED DESCRIPTION OF EXEMPLARY EMBODIMENTS

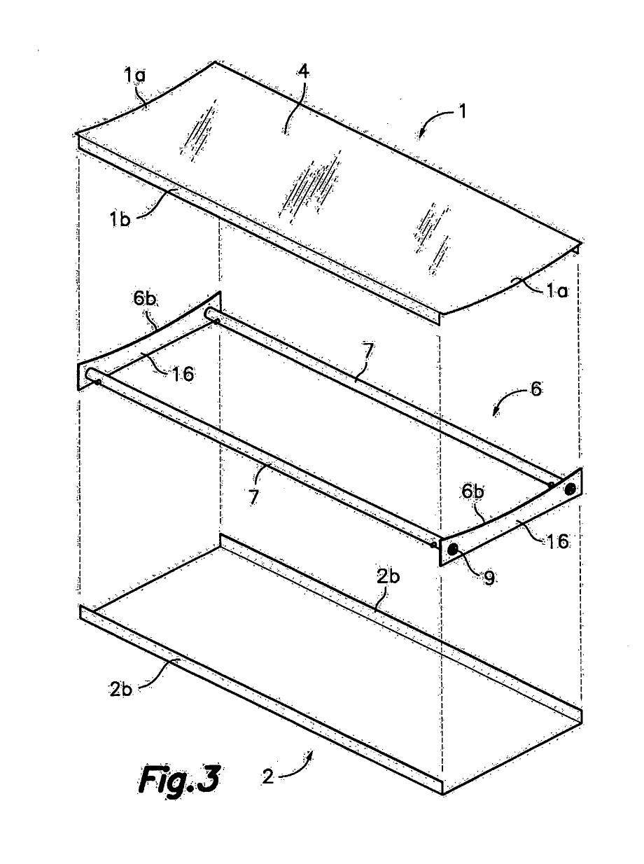

Referring first to FIGS. 1 to 5, reference number 30 generally designates a reflector-concentrator unit according to a first embodiment of the first aspect of the present invention, comprising a sandwich structure with an upper lamina 1, a lower lamina 2 and a filler layer 3 (FIG. 5) between both. The mentioned upper lamina 1 is made of a metallic material, such as, for example, an aluminum alloy sheet, and has a polished outer surface which functions as a reflective surface. The upper lamina 1 is shaped as a parallel ruled concave surface, suitable for reflecting substantially or approximately parallel incident rays and for concentrating the reflected rays in a linear focus. Alternatively, the upper lamina 1 can simply function as a support for one or more reflective surface elements adhered or otherwise attached thereto. The mentioned sandwich structure is associated with a frame 6 (best shown in FIG. 3), such that the upper and lower laminas 1, 2, the frame 6 and the layer of filler material 3 jointly form the reflector-concentrator unit 30. Throughout this description, the term “longitudinal direction” will be used to designate a direction substantially parallel to the direction of the ruled concave surface of the upper lamina 1, and accordingly parallel to the linear focus.

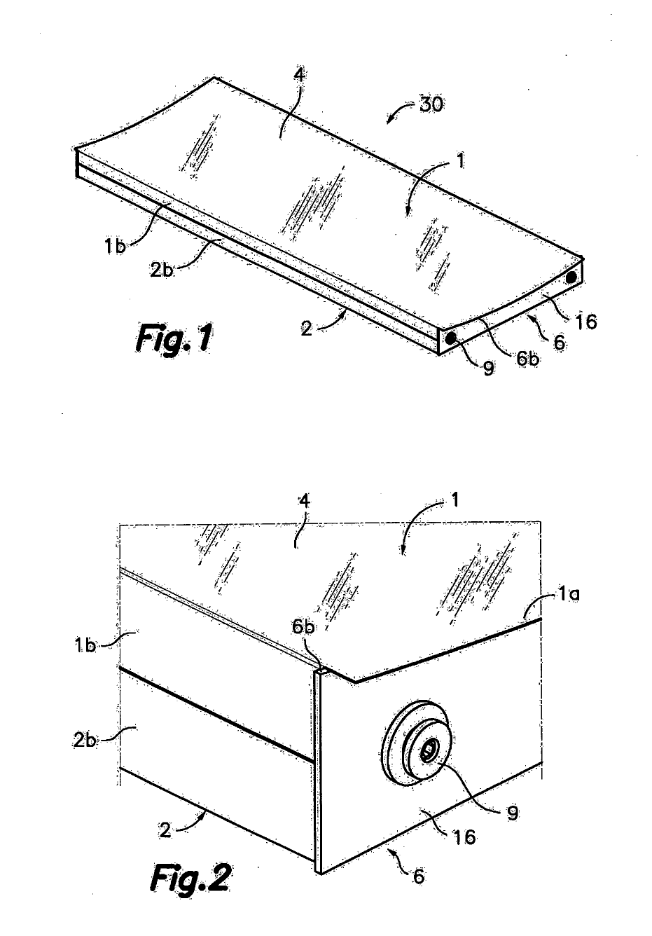

The material of the filler layer 3, which can be, for example, expanded polyurethane foam, is adhered to the upper and lower laminas 1, 2 of the sandwich structure and to frame 6. The material of the filler layer 3 is significantly lightweight and at the same time rigid enough to precisely assure a predetermined stable operating position of the upper lamina 1 in relation to the frame 6. Furthermore, the frame 6 comprises positioning configurations 9 (see the detail of FIG. 2) which can be used to precisely position the reflector-concentrator unit 30, and the reflective surface associated therewith, in relation to an external element (not shown) of an installation, such as a supporting element for the reflector-concentrator unit 30, or an element of a support for a collector, among others.

As is shown in FIG. 3, the upper lamina 1 of the sandwich structure has side portions lb bent downwards and the lower lamina 2 has side portions 2b bent upwards. In the reflector-concentrator unit 30, the material of the filler layer 3 is adhered internally to said side portions 1b, 2b of the upper and lower laminas 1, 2. The frame 6 of the reflector-concentrator unit 30 is made up of a pair of opposite end plates 16, transverse to the longitudinal direction, or direction of the linear focus. Each of the mentioned end plates 16 has an upper concave edge configured to cooperate with a corresponding end portion la of the upper lamina 1 to position the upper lamina 1 and its reflective surface in relation to said frame 6. In the first embodiment shown in FIGS. 1 to 5, the upper lamina 1 defines a single reflecting element 4 capable of concentrating the reflected rays in a single linear focus, and said upper edge of each of the end plates 16 defines a seat 6b for supporting the end portions 1a of the upper lamina 1 corresponding to said reflecting element 4. The two end plates 16 of the frame 6 are connected to one another by means of spacer members 7 which, in the reflector-concentrator unit 30, are arranged through the filler layer 3 and embedded therein, as is shown in the detail of FIG. 5.

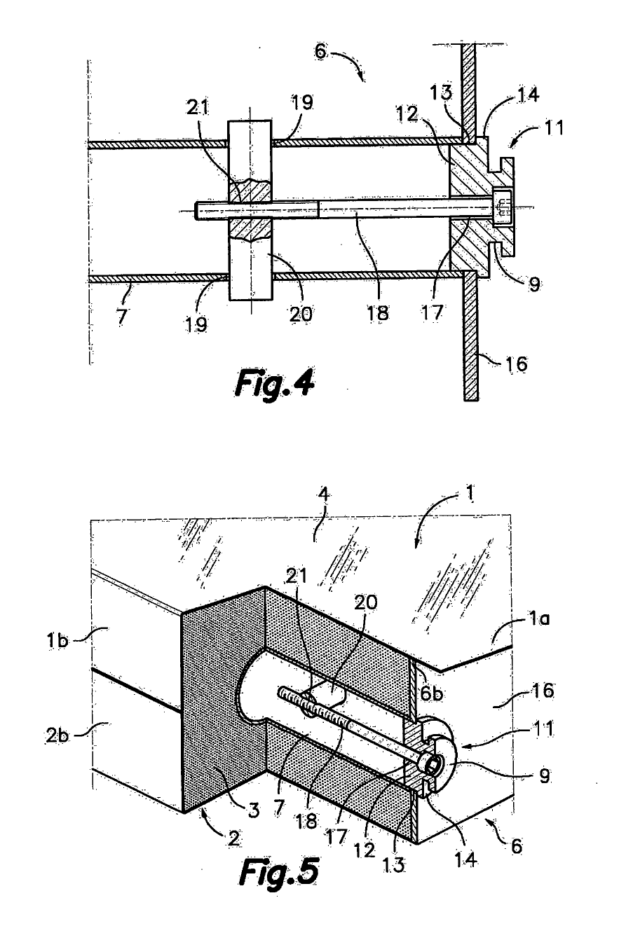

According to the example illustrated in FIGS. 4 and 5, each of the spacer members 7 is formed by a portion of cylindrical metal tube attached to the end plates 16 by means of attachment parts 11 which furthermore define the mentioned positioning configurations 9. Each of said attachment parts 11 comprises a cylindrical portion 12 inserted through a hole 13 formed in the corresponding end plate 16 and socket-coupled in the hollow interior of an end of the spacer member 7. The attachment part 11 has a widened outer portion 14 which is supported against an outer surface of the end plate 16 around said hole 13, and an axial hole 17 through which a screw 18 is installed. At a certain distance from its end, the spacer member 7 has formed therein a pair of facing radial holes 19, through which there is arranged a solid pin 20 provided with a radial threaded hole 21 in which the screw 18 is coupled. Advantageously, the attachment part 11 has the form of a body of revolution, and the positioning configuration 9 comprises, for example, a circumferential slot formed in an outer portion thereof to cooperate with a conjugate notch formed in a wall of the mentioned external element. Thus, the positioning configuration 9 is perfectly centered in the hole of the end plate 16 of the frame 6 and, since the material of the filler layer 3 securely maintains the relative positions between the upper lamina 1 and the frame 6, the positioning configuration 9 functions as a reliable reference in the precise positioning of the reflective surface with respect to the external element.

The end plates 16 and the spacer members 7 of the frame 6, as well as the lower lamina 2, can be made of a metallic material such as, for example, galvanized steel or stainless steel. However, a frame made of other alternative materials, including materials which can be shaped by molding, is included within the scope of the present invention.

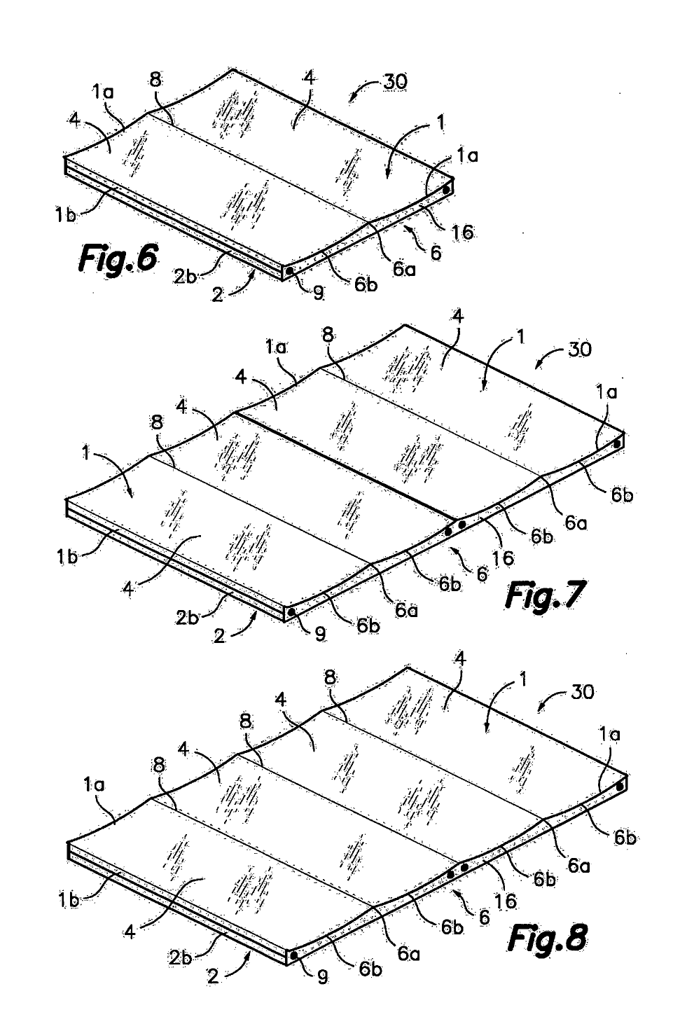

FIG. 6 shows a second embodiment of the reflector-concentrator unit 30 where the upper lamina 1 defines a pair of reflecting elements 4, each capable of concentrating the reflected rays in a respective linear focus. Thus, adjacent edges of said pair of reflecting elements 4 converge in a central linear fold 8 formed in the longitudinal direction of the upper lamina 1. The mentioned upper edge of each of the end plates 16 of the frame 6 defines a central vertex 6a which cooperates with the mentioned linear fold 8 to position the upper lamina 1 and its reflective surfaces in relation to said frame 6. The upper edge of each end plate 16 furthermore defines a pair of concave seats 6b, one on either side of said vertex 6a, for supporting the end portions la of the lamina 1 corresponding to said pair of reflecting elements 4. The upper and lower laminas 1, 2 include respective side portions 1b, 2b bent downwards and upwards, respectively. The constitution of the sandwich structure and the construction of the frame 6 can be identical to those described above in relation to the first embodiment.

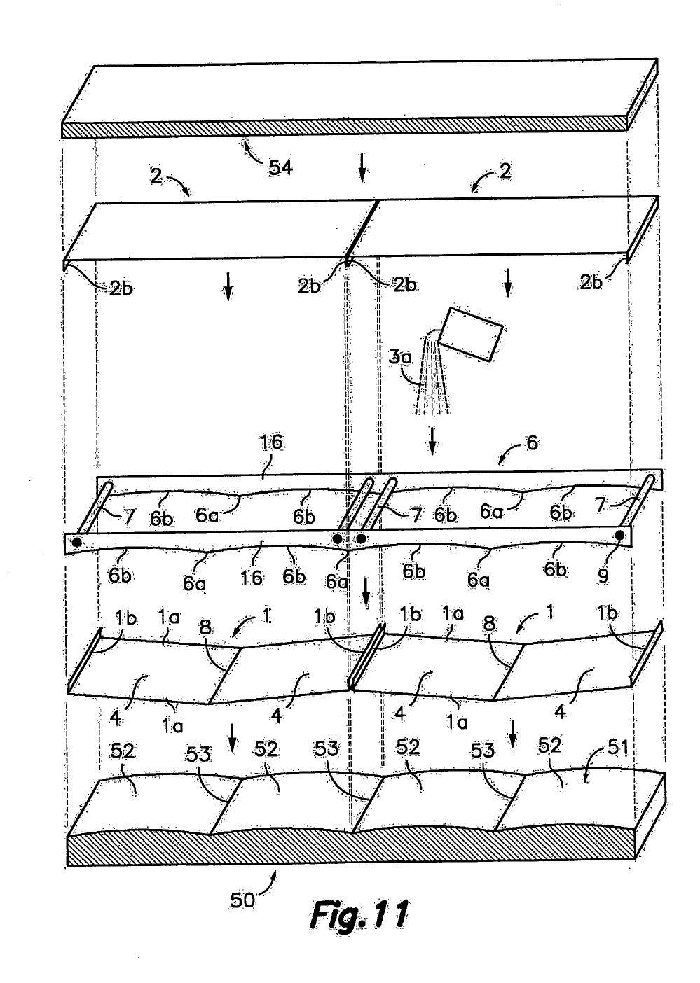

FIG. 7 shows a third embodiment of the reflector-concentrator unit 30, in which a single frame 6 supports two upper laminas 1, each of which has a central linear fold 8 and a pair of reflecting elements 4, one on either side of the central linear fold 8, similarly to the upper lamina 1 of the second embodiment illustrated in FIG. 6. Each reflecting element 4 is configured to concentrate the reflected rays in a respective linear focus. The upper edge of each end plate 16 of the frame 6 defines two vertexes 6a which cooperate with the two linear folds 8 of the two respective upper laminas 1 and two pairs of seats 6b, with a seat 6b of each pair on either side of a corresponding vertex 6a. The end portions 1a of each upper lamina 1 corresponding to the pair of reflecting elements 4 are supported in the corresponding pair of seats 6b of each end plate 16. There can be several lower laminas 2, although a single one is enough for two upper laminas 1. The upper and lower laminas 1, 2 include respective side portions 1b, 2b bent downwards and upwards, respectively. The lower lamina 2 is preferably only one in number, although this is not an indispensable condition. The upper laminas 1 and the lower lamina 2 include respective side portions 1b, 2b bent downwards and upwards, respectively. The constitution of the sandwich structure and the construction of the frame 6 can be identical to those described above in relation to the first and second embodiments, with the exception that due to the greater length of the end plates 16, the frame 6 optionally includes additional spacer members 7 in a middle area (see FIG. 11). It will be understood that this third embodiment allows for a number of upper laminas 1 greater than two, and each upper lamina 1 will generally define a pair of reflecting elements 4, although this is not an indispensable condition. The upper edge of each end plate 16 of the frame 6 obviously defines one or more additional vertexes, each additional vertex being arranged in the gap between two upper laminas 1.

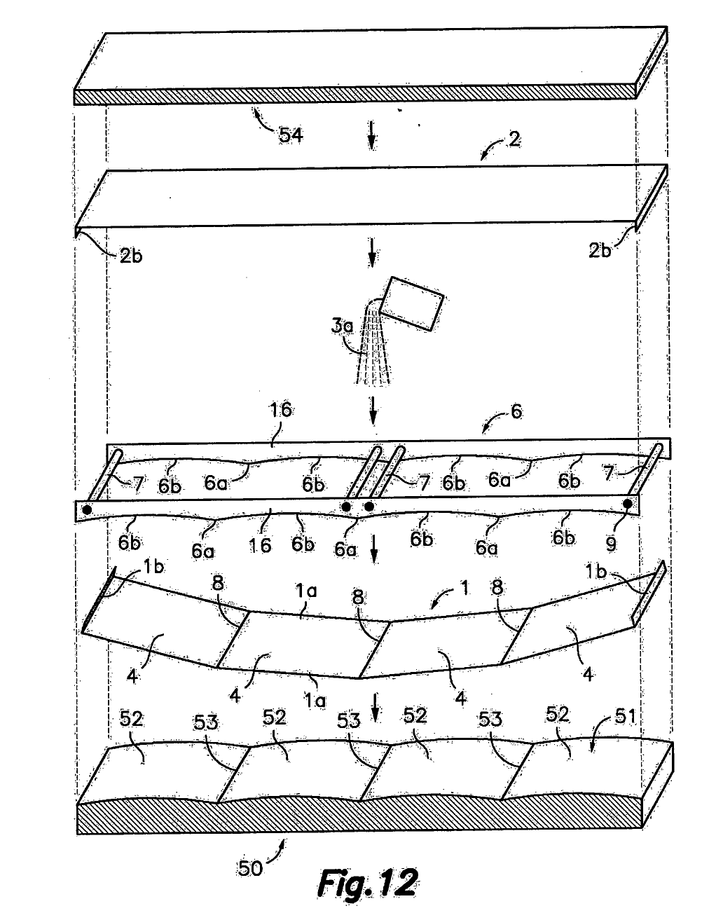

FIG. 8 shows a fourth embodiment of the reflector-concentrator unit 30, in which the upper lamina 1 defines four reflecting elements 4, each capable of concentrating the reflected rays in a respective linear focus. Here, the upper lamina 1 defines three longitudinal linear folds 8, in each of which adjacent edges of two of said reflecting elements 4 converge. The upper edge of each of the end plates 16 of the frame 6 defines three vertexes 6a which cooperate with the mentioned three linear folds 8 to contribute to positioning the upper lamina 1 and its reflective surfaces in relation to the frame 6. There are also formed on either of each vertex 6a in the upper edge of each end plate 16 concave seats 6b envisaged for supporting the end portions la of the lamina 1 corresponding to the four reflecting elements 4. The constitution of the sandwich structure can be identical to the one described above in relation to the previous embodiments and the construction of the frame 6 can be identical to the one of the third embodiment (see FIG. 12). It will be understood that in this fourth embodiment, the number of reflecting elements 4 is not limited to four, there being able to be only three or more than four, with a subsequent adaptation in the end plates 16 of the frame 6.

The reflector-concentrator unit 30 of the present invention is obviously susceptible to many variations with respect to the examples illustrated in the drawings both in relation to the shape and arrangement of the upper and lower laminas 1, 2 and to the shape and construction of the frame 6 and positioning configurations 9. For example, the upper and lower laminas 1, 2 can lack the respective bent side portions 1b, 2b, and the latter can possibly be replaced with side plates forming part of the frame, or only one of the upper and lower laminas 1, 2 may have bent side portions. In addition, each reflective surface portion can be a reflective parallel ruled concave surface, for example with a parabolic or approximately parabolic cross-section, or it can include several adjacent sections with a parabolic or approximately parabolic cross-section, or a plurality of planar adjacent reflective surface sections arranged as a Fresnel mirror.

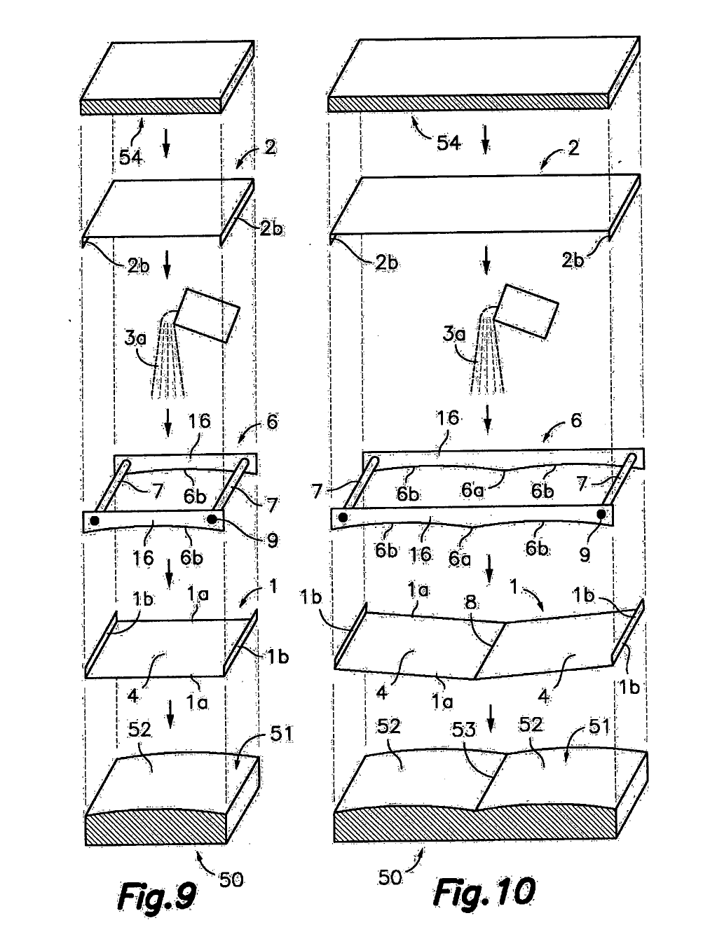

Now with reference to FIGS. 9 to 12, a method according to a second aspect of the present invention for manufacturing a reflector-concentrator unit 30 of the type described above in relation to FIGS. 1 to 8 is described below. Each of the four FIGS. 9 to 12 illustrates a different embodiment of the method suitable for each of the four embodiments of the reflector-concentrator unit 30 described above, and the different consecutive steps of the method are schematically illustrated from the bottom to the top.

FIG. 9 illustrates a first embodiment of the method of the present invention suitable for manufacturing a reflector-concentrator unit 30 like the one of the first embodiment described above in relation to FIGS. 1 to 5, where a first step comprises providing a mold 50 in the form of a box with a shaped bottom 51 which reproduces the negative of the reflective surface of the reflector-concentrator unit 30 and side walls (not shown for greater clarity). As has been explained above, in this first embodiment the reflective surface includes a single reflecting element 4. The next step comprises introducing the upper lamina 1 in said mold 50 face down, i.e., with the corresponding reflective surface facing the mentioned shaped bottom 51. Due to its relative thinness, the upper lamina 1 is substantially flexible and at rest substantially planar except the side portions lb bent downwards, which are now aimed upwards. Next, the method comprises introducing the frame 6 in the mold 50 face down above the upper lamina 1. In the illustrated embodiment, the upper edges of the end plates 16 have formed therein respective seats 6b which will be applied on the end portions la of the upper lamina 1 corresponding to the reflecting element 4 which contributes to positioning the frame 6 inside the mold 50 and to shaping the upper lamina 1. However, it is possible for the frame 6 to not have said seats formed therein for the upper lamina 1, in which case the mold 50 could have positioning configurations capable of cooperating with the positioning configurations 9 of the frame 6 to precisely position the frame inside the mold 50 and in relation to the shaped bottom 51. Other characteristic configurations of the frame 6 in cooperation with positioning configurations (not shown) of the mold 50 can optionally be used to precisely position the frame 6 in relation to the shaped bottom 51 of the mold 50 during the molding operation.

The next step comprises pouring a flowable material 3a in the mold 50 above said frame 6 and the upper lamina 1, filling the mold 50 up to a predetermined level. The mentioned flowable material 3a is capable of expanding and hardening to form the filler layer 3, and of adhering to the surfaces contacting with it, including surfaces of the frame 6 and of the upper lamina 1. The spacer members 7 of the frame 6 will be embedded in the material of the filler layer 3. Then the method comprises introducing the lower lamina 2 in the mold 50 face down above the flowable material 3a, i.e., with the side portions 2b bent upwards now aimed downwards. Finally, the method comprises the steps of closing the mold 50, placing a cover 54 on the lower lamina 2, fixing it at a predetermined distance from the shaped bottom 51, and then allowing the flowable material 3a to expand and harden until forming the filler layer 3. The expansion of the flowable material 3a contributes to strongly pressing the upper lamina 1 against the shaped bottom 51 of the mold 50, such that the reflecting element 4 of the upper lamina acquires the form of the shaped bottom 51 of the mold 50. Obviously, the pressure produced by the expansion of the flowable material 3a also presses the lower lamina 2 against the mentioned cover 54. Once a predetermined time has elapsed, the recently formed filler layer 3 is hardened and firmly adhered to the upper and lower laminas 1, 2 and to the frame 6, providing cohesion and consistency to the reflector-concentrator unit 30.

The reflector-concentrator unit 30 thus formed comprises a sandwich structure with an upper lamina 1, a lower lamina 2 and a filler layer 3 between both, and a frame 6 provided with positioning configurations 9. The upper lamina 1 has associated therewith an outer reflective surface and is shaped to reflect incident rays and to concentrate the reflected rays in at least one linear focus. Due to the precise positioning of the upper lamina 1 and the frame 6 inside the mold 50 in relation to the shaped bottom 51 thereof, in the reflector-concentrator unit 30 the positioning configurations 9 are very precisely positioned in relation to the reflecting portion 4 and constitute a reference usable for placing the reflector-concentrator unit 30 in relation to an external element of an installation.

The method of the invention comprises some prior steps. For example, the upper lamina 1 can be previously formed starting from a sheet of metal, such as, for example, an aluminum alloy sheet, and polishing an outer surface of the upper lamina 1 enough to function as the reflective surface. The frame 6 can be formed by preparing the end plates 16 by means of a metallic material, such as galvanized steel, and by connecting the end plates 16 to one another by means of spacer members 7 made of the same or of a different material. The frame 6 will be introduced in the mold 50 with said spacer members 7 positioned so as to be embedded in the filler layer 3 once the flowable material 3a has expanded and hardened. The flowable material 3a can be prepared immediately before being poured by mixing two or more suitable components to form a polyurethane foam. The lower lamina 2 can be prepared from a sheet of metal, for example, a sheet of galvanized steel.

In relation to FIG. 10, a second embodiment of the method of the present invention suitable for manufacturing a reflector-concentrator unit 30 like the one of the second embodiment described above in relation to FIG. 6 is described below. This second embodiment of the method is essentially the same as the first one except in that it comprises forming the shaped bottom 51 of the mold 50 with two mold portions 52, each according to the negative of a reflecting element 4 capable of concentrating the reflected rays in a respective linear focus. Adjacent edges of said mold portions 52 converge in a central groove 53. The step of forming the upper lamina 1 is also different, comprising in this case a central longitudinal linear fold 8 between at least two reflecting elements 4. Then, the step of introducing the upper lamina 1 in the mold 50 is done by placing said linear fold 8 in coincidence with said groove 53 in the shaped bottom 51 of the mold 50. This second embodiment of the method comprises forming the frame 6 with a vertex 6a in an upper edge of each end plate 16, and introducing in the mold 50 the frame 6 placing said vertex 6a of each end plate 16 in coincidence with the linear fold 8 of the upper lamina 1 to press the linear fold 8 against the groove 53 of the shaped bottom 51 of the mold 50. Preferably, the method comprises forming the frame 6 with at least two seats 6b, one on either side of said vertex 6a in the upper edge of each end plate 16 and introducing the frame 6 in the mold 50 with said seats 6b pressing the end portions la of the upper lamina 1 corresponding to the two reflecting elements 4. The next steps of pouring the flowable material 3a, placing the lower lamina 2 and closing the mold with the cover 54 are the same as in the previous example.

FIG. 11 illustrates a third embodiment of the method of the present invention suitable for manufacturing a reflector-concentrator unit 30 like the one of the third embodiment of the first aspect described above in relation to FIG. 7, which includes the steps of forming the shaped bottom 51 of the mold 50 with four mold portions 52 separated by corresponding longitudinal grooves 53, forming two upper laminas 1, each similar to the upper lamina 1 of the second embodiment, with a central linear fold 8 between two reflecting elements 8, and introducing the two upper laminas 1 inside the mold 50 one next to the other and with the linear fold 8 of each upper lamina 1 in coincidence with a corresponding groove 53 in the shaped bottom 51 of the mold 50. Here, the method comprises forming the frame 6 with four seats 6b separated by three vertexes 6a in an upper edge of each end plate 16, and introducing the frame 6 in the mold 50 with the vertexes 6a in coincidence with a corresponding linear fold 8 of each upper lamina 1 to press the linear folds 8 against the grooves 53 of the shaped bottom 51 of the mold 50, and with said seats 6b pressing the end portions la of each upper lamina 1 corresponding to the two respective reflecting elements 4. The next steps of pouring the flowable material 3a, placing the lower lamina 2 and closing the mold with the cover 54 are the same as in the previous example. FIG. 11 shows two lower laminas 2 arranged for being introduced in the mold 50, each facing a corresponding one of the upper laminas 1. However, a single lower lamina 2 with equivalent length could alternatively be prepared. This third embodiment of the method can obviously be readily adapted to the manufacture of reflector-concentrator units 30 with a larger number of pairs of reflecting elements 4 by adding upper laminas 1 and adapting the mold 50 and the frame 6 accordingly.

Finally, FIG. 12 describes a fourth embodiment of the method of the present to invention suitable for manufacturing a reflector-concentrator unit 30 like the one of the fourth embodiment of the first aspect described above in relation to FIG. 8. This fourth embodiment of the method comprises forming the shaped bottom 51 of the mold 50 and the frame 6 similarly to the previous example and forming an upper lamina 1 with four reflecting elements 4 separated by corresponding longitudinal linear folds 8. Then, the upper lamina 1 is placed in the mold 50 with the linear folds 8 in coincidence with the corresponding grooves 53 in the shaped bottom 51 of the mold 50, and next the frame 6 is placed inside the mold 50, placing the vertexes 6a of each end plate 16 in coincidence with the corresponding linear folds 8 of the upper lamina 1 to press the linear folds 8 against the grooves 53 of the shaped bottom 51 of the mold 50, and with said seats 6b pressing the end portions la of the upper lamina 1 corresponding to the four reflecting elements 4. The next steps of pouring the flowable material 3a, placing the lower lamina 2 and closing the mold with the cover 54 are the same as in the previous example. A person skilled in the art would easily think of the variations necessary for adapting this fourth embodiment of the method to the manufacture of reflector-concentrator units 30 with three or more than four reflecting elements 4.

Alternatively, also in the second, third and fourth embodiments of the method, the frame 6 could be prepared without vertexes 6a or seats 6b, in which case the positioning configurations 9 or other configurations of the frame 6 would be used in cooperation with positioning configurations (not shown) of the mold 50 to precisely position the frame 6 in relation to the shaped bottom 51 of the mold 50 during the molding operation. The method likewise contemplates forming the upper lamina 1 with side portions 1b bent downwards, or forming the lower lamina 2 with side portions 2b bent upwards, or a combination of both. In any case, the side portions 1b, 2b bent downwards and/or upwards will preferably be configured to contain the flowable material 3a before and after expanding inside the mold 50. When both upper and lower laminas 1, 2 include respective side portions 1b, 2b bent downwards and upwards, respectively, they can be configured to be facing head-on or overlapped inside the mold 50, and accordingly in the finished reflector-concentrator unit 30.

With reference now to FIGS. 13 to 15, several embodiments of a solar collector device using one or more reflector-concentrator units 30 according to the present invention or manufactured according to the method of the present invention, are described below.

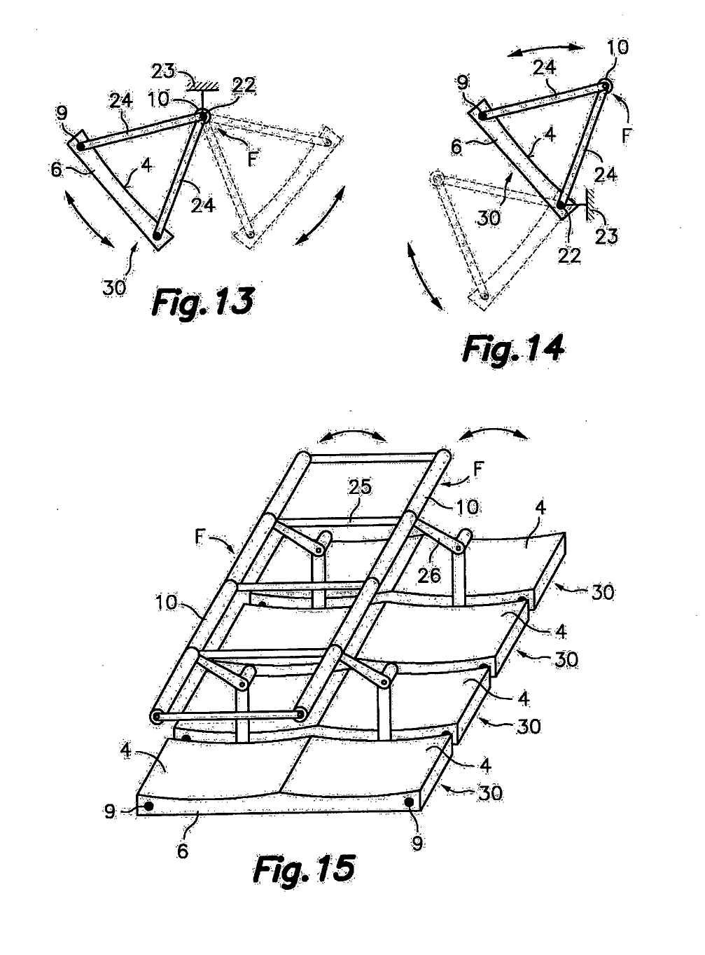

In the first and second embodiments shown in FIGS. 13 and 14, respectively, the device comprises a reflector-concentrator unit 30 which includes a single reflecting element 4 arranged to reflect the sun's rays and to concentrate them in a linear focus F, and an elongated receiver 10 capable of capturing the thermal or photovoltaic energy of the sun's reflected rays. The mentioned elongated receiver 10 is supported by rigid supporting elements 24 with respect to the frame 6 in the position which has said linear focus F when the sun's incident rays are normal to the reflecting element 4. The positioning configurations 9 of the reflector-concentrator unit 30 have advantageously been used for the precise positioning of the elongated receiver 10 with respect to the reflecting element 4. The reflector-concentrator unit 30 and elongated receiver 10 assembly is assembled such that it can pivot around a shaft 22 which has a stationary position with respect to a fixed structure 23 (symbolically depicted), and connected to a tracking mechanism (not shown) suitable for pivoting the reflector-concentrator unit 30 and elongated receiver 10 assembly with respect to said shaft 22 for the purpose of keeping the reflecting portion 4 of the reflector-concentrator unit 30 normal to the sun's incident rays as the relative position of the sun changes.

In the first embodiment shown in FIG. 13, the shaft 22 is aligned with the linear focus F, such that the center of the elongated receiver 10 remains stationary with respect to the fixed structure 23, and the reflector-concentrator unit 30 pivots with respect to the center of the elongated receiver 10. In the second embodiment shown in FIG. 14, the shaft 22 is parallel to the linear focus F and is located on an end of the frame 6 of the reflector-concentrator unit 30, although it could be located in any other site, preferably on or close to the reflector-concentrator unit 30. It will be understood that the second embodiment is not limited to a reflector-concentrator unit 30 with a single reflecting element 4, one or more reflector-concentrator units 30 with several reflecting elements 4 being able to be used.

The third embodiment of the solar collector device shown in FIG. 15 comprises a series of reflector-concentrator units 30, each with two reflecting elements 4, fixed to a fixed structure (not shown) and placed such that the respective reflecting elements 4 are aligned and arranged to reflect the sun's incident rays and to concentrate them in two corresponding linear foci F. Two elongated receivers 10 are attached to a mobile structure 25 supported by mobile arms 26 of a tracking mechanism configured to move the mobile structure 25 so that the elongated receivers 10 follow the maximum convergence of the sun's reflected rays as the position of the sun changes in relation to the reflecting elements 4. In this third embodiment, the positioning configurations 9 can be used to precisely position the reflector-concentrator units 30 in relation to the fixed structure and/or in relation to base elements of the tracking mechanism. Likewise, the reflector-concentrator units 30 are not necessarily limited to two reflecting elements 4, being able to have only one or more than two, and they can be arranged in form of an array.

A person skilled in the art will be able to make modifications and variations from the embodiments shown and described without departing from the scope of the present invention as it is defined in the attached claims.

1-25. (canceled)

26. A reflector-concentrator unit, comprising:
a sandwich structure with at least one upper lamina;
at least one lower lamina; and
a filler layer between said upper lamina and lower lamina, where said at least one upper lamina has associated therewith an outer reflective surface and is shaped to reflect incident rays and to concentrate the reflected rays in at least one linear focus, wherein:
said sandwich structure is associated with a rigid frame;
the material of said filler layer is adhered to at least said upper lamina of the sandwich structure and to said frame;
the material of the filler layer is rigid enough to precisely assure a predetermined stable operating position of the upper lamina in relation to the frame; and
the frame comprises positioning configurations usable to precisely position the reflector-concentrator unit and the reflective surface associated thereto in relation to an external element of an installation.
wherein the frame comprises:
opposite end plates, transverse to a direction of said linear focus;
holes formed in said end plates;
attachment parts partially inserted in said holes formed in said end plates, said positioning configurations being formed in said attachment parts at outer sides of the end plates; and
connecting members arranged through the filler layer and connected at their ends to the attachment parts to connect the end plates to one another.

27. The reflector-concentrator unit according to claim 26, wherein each connecting member is formed by a portion of metal tube, and each attachment part comprises an inner part inserted through said hole of the end plate and socket-coupled in a hollow interior of the connecting member, and a widened outer portion which is supported against an outer surface of the end plate, a portion of the end plate around said hole being trapped between the connecting member and said widened outer portion of the attachment part.

28. The reflector-concentrator unit according to claim 27, wherein the attachment part has an axial hole through which a screw is installed and connected to a radial threaded hole formed in a pin transversally connected to the connecting member.

29. The reflector-concentrator unit according to claim 26, wherein the positioning configuration of the attachment part comprises a circumferential slot formed in an outer portion thereof to cooperate with a conjugate notch formed in a wall of the mentioned external element.

30. The reflector-concentrator unit according to claim 26, wherein each of the end plates has an upper edge configured to cooperate with a corresponding end portion of the upper lamina to position the upper lamina and its reflective surface in relation to said frame.

31. The reflector-concentrator unit according to claim 30, wherein the upper lamina defines at least one reflecting element capable of concentrating the reflected rays in a linear focus, and said upper edge of each of the end plates defines at least one seat for supporting said end portions of the upper lamina corresponding to said at least one reflecting element.

32. The reflector-concentrator unit according to claim 30, wherein the upper lamina defines at least one pair of reflecting elements, each capable of concentrating the reflected rays in a respective linear focus, and comprises at least one longitudinal linear fold in which adjacent edges of said pair of reflecting elements converge, and said upper edge of each of said end plates defines at least one vertex which cooperates with said at least one to position the upper lamina and its reflective surface in relation to said frame.

33. The reflector-concentrator unit according to claim 32, wherein the upper edge of each end plate defines at least one pair of seats, one on either side of said vertex, for supporting end portions of the upper lamina corresponding to said pair of reflecting elements.

34. The reflector-concentrator unit according to claim 30, further comprising a number of upper laminas, each with a linear fold and a pair of reflecting elements, one on either side of the linear fold, and the upper edge of each end plate defines an equal number of vertexes, where each vertex of each end plate cooperates with the linear fold of one of the upper laminas.

35. The reflector-concentrator unit according to claim 34, wherein the upper edge of each end plate defines an equal number of pairs of seats, with a seat of each pair on either side of a corresponding vertex, where end portions corresponding to each pair of reflecting elements of each upper lamina are supported in the corresponding pair of seats of each end plate.

36. The reflector-concentrator unit according to claim 26, wherein the upper lamina or each upper lamina has side portions bent downwards and the material of the filler layer is adhered to said side portions.

37. The reflector-concentrator unit according to claim 26, wherein the lower lamina has side portions bent upwards and the material of the filler layer is adhered to said side portions.

38. The reflector-concentrator unit according to claim 26, wherein the upper lamina is made of a metallic material and has a polished outer surface which functions as the reflective surface.

39. The reflector-concentrator unit according to claim 38, wherein the material of the upper lamina is an aluminum alloy.

40. The reflector-concentrator unit according to claim 26, wherein the material of the filler layer is a polyurethane foam.

41. A method of manufacturing a reflector-concentrator unit comprising a sandwich structure with at least one upper lamina, at least one lower lamina and a filler layer between both, where said at least one upper lamina has associated therewith an outer reflective surface and is shaped to reflect incident rays and to concentrate the reflected rays in at least one linear focus, the method comprising the steps of:
providing a mold in the form of a box with a shaped bottom according to the negative of said reflective surface of the reflector-concentrator unit;
introducing the at least one upper lamina in said mold with the reflective surface facing said shaped bottom;
introducing a frame in the mold above the at least one upper lamina, said frame having opposed end plates connected to one another by connecting members;
pouring a flowable material in the mold above said frame and the at least one upper lamina filling the mold up to a predetermined level, said flowable material being capable of expanding and hardening to form said filler layer and of adhering to at least said frame and to the at least one upper lamina;
introducing said lower lamina in the mold above said flowable material;
placing a cover on the lower lamina, fixing it at a predetermined distance from the shaped bottom; and
allowing the flowable material to expand and harden until forming the filler layer, the expansion of said flowable material contributing to pressing the at least one upper lamina against the shaped bottom of the mold in order to shape it according to the form of the shaped bottom of the mold.

42. The method according to claim 41, further comprising providing the frame with positioning configurations usable to precisely position said reflector-concentrator unit and the associated reflective surface in relation to an external element of an installation, and using said positioning configurations or other configurations of the frame in cooperation with positioning configurations of the mold to precisely position the frame in relation to the shaped bottom of the mold during the molding operation.

43. The method according to claim 41, further comprising positioning the frame in the mold with at least part of an upper edge of each end plate pressing a corresponding end portion of the at least one upper lamina against the shaped bottom of the mold.

44. The method according to claim 43, further comprising:
forming the shaped bottom of the mold with at least two mold portions, each according to the negative of a reflecting element capable of concentrating the reflected rays in a respective linear focus, with adjacent edges of said mold portions converging in at least one groove;
forming the at least one upper lamina with at least one longitudinal linear fold between at least two reflecting elements and introducing the at least one upper lamina in the mold placing said linear fold in coincidence with said groove in the shaped bottom of the mold; and
forming the frame with at least one vertex in an upper edge of each end plate, and introducing the frame in the mold, placing said vertex of each end plate in coincidence with the linear fold of the at least one upper lamina to press the linear fold against the shaped bottom of the mold.

45. The method according to claim 44, further comprising forming the frame with at least two seats, one on either side of said at least one vertex in the upper edge of each end plate, and introducing the frame in the mold with said seats pressing said end portion corresponding to each reflecting element of the at least one upper lamina.

46. The method according to claim 45, further comprising forming several upper laminas, each with at least one longitudinal linear fold, and introducing the several upper laminas in the mold, placing the respective linear folds in coincidence with corresponding grooves in the shaped bottom of the mold.

47. The method according to claim 41, further comprising shaping the upper lamina with side portions bent downwards and configured to contain, at least in part, the flowable material inside the mold and/or shaping the lower lamina with side portions bent upwards and configured to contain, at least in part, the flowable material inside the mold.

48. The method according to claim 43, further comprising forming the frame by connecting the end plates to one another by means of connecting members, and introducing the frame in the mold with said connecting members positioned so as to be embedded in the filler layer once the flowable material has expanded and hardened.

49. The method according to claim 41, further comprising preparing the flowable material by mixing at least two suitable components to form a polyurethane foam.

50. The method according to claim 41, further comprising forming the upper lamina from an aluminum alloy sheet and polishing an outer surface of the upper lamina enough to function as the reflective surface.

51. A solar collector device, comprising at least one reflector-concentrator unit according to claim 26 arranged to reflect the sun's rays, and at least one elongated receiver supported in the position of said linear focus or moved to track the maximum convergence of the sun's reflected rays as the position of the sun changes in relation to the reflective surface.

52. A solar collector device, comprising at least one reflector-concentrator unit or manufactured according to the method of claim 41 arranged to reflect the sun's rays, and at least one elongated receiver supported in the position of said linear focus or moved to track the maximum convergence of the sun's reflected rays as the position of the sun changes in relation to the reflective surface.
